(19) United States
(12) Patent Application Publication
(10) Pub. No.: US 2007/0040761 A1
(43) Pub. Date: Feb. 22, 2007

(54) Method and apparatus for wideband omni-directional folded beverage antenna

(75) Inventor: Rodney B. Waterhouse, Columbia, MD (US)

Correspondence Address: Min, Hsieh & Hack, L.L.P.;c/o PortfoliolP, P.O. Box 52050, Minneapolis, MN, 55402, US

(73) Assignee: Pharad, LLC.

(21) Appl. No.: 11/203,999

(22) Filed: Aug. 16, 2005

(51) Int. Cl. H01Q 1/36

(52) U.S. Cl. 343/895

(57) ABSTRACT

An embodiment generally relates to a wave antenna. The wave antenna includes a grounded substrate and a probe feed configured to be substantially centered within the grounded substrate. The wave antenna also includes a load configured to be a linear distance from the probe feed and a conductor trace configured to connect the probe feed and the load. The pattern for the conductor trace is substantially a spiral and the radiation response of the wave antenna is substantially omni-directional.

### FIELD

This invention relates generally to antennas. More particularly, the invention relates to wideband omni-directional folded Beverage antennas.

### DESCRIPTION OF THE RELATED ART

One of the most well known traveling-wave antennas is the Beverage, long wire, or wave antenna. The antenna was invented in the early 1920's by Harold Beverage and variations of this form of radiator are very common, in particular in the Medium Frequency (300 kHz-3 MHz) and High Frequency (3-30 MHz) frequency ranges. Here a long wire mounted above the ground is excited at one end and terminated at the other port. The antenna is designed to have uniform patterns in both current and voltage. To achieve this, the wire antenna must be appropriately terminated to ensure no reflections occur. The length of this form of antenna ranges from one to many wavelengths.

A classic Beverage receiving antenna requires a lot of space. It is a long wire, one or more wavelengths long, mounted near to the ground and oriented in the direction of the desired reception. A nominal 9:1 balun is required at the juncture of the wire and 50- or 75-Ohm coaxial feedline. The far end is terminated with a nominal 600-ohm resistance. However, when available space will not permit the installation of a “full length” Beverage, some people install “short” Beverages, ranging in length from about 300 feet up to 600 feet or so.)

The real estate issues related to a full-sized Beverage antenna make it difficult for a typical mobile user to utilize the Beverage antenna. However, it is possible to realize a printed version of a Beverage antenna. In this configuration, a probe soldered to the microstrip line is used to excite the antenna. The characteristic impedance of the transmission line is designed as 50 Ω, thus the termination resistance is also this value. The microstrip antenna can be well matched over a very wide bandwidth (in excess of a decade) and its typical radiation pattern (including gain) is directed towards the direction of wave propagation, that is, endfire. This radiation response is consistent with a conventional Beverage antenna and therefore it is not appropriate for applications requiring near omni-directional coverage.

### SUMMARY

One embodiment pertains to a wave antenna. The wave antenna includes a grounded substrate and a probe feed configured to be substantially centered within the grounded substrate; The wave antenna also includes a load configured to be a linear distance from the probe feed and a conductor trace configured to connect the probe feed and the load. The pattern for the conductor trace is substantially a spiral, where the radiation response of the wave antenna is substantially omni-directional.

Another embodiment relates to a three-dimensional wave antenna. The three-dimensional wave antenna includes a three dimensional structure comprised of a grounded substrate and a probe feed configured to be substantially located on one end of a surface of the three dimensional structure. The three-dimensional wave antenna also includes a load configured to be located on a second end of the surface of the three dimensional structure and a conductor trace configured to connect the probe feed and the load. The pattern for the conductor trace is substantially a spiral over the surface of the three dimensional structure.

Yet another embodiment pertains to a method for forming a wave antenna. The method includes providing a grounded substrate, the grounded substrate having a length, a width and a height dimension. The method also includes providing a probe feed to be substantially located in a center of the grounded substrate and providing a load to be substantially located on an edge of the grounded substrate. The method further includes providing a conductor trace from the probe feed to the load, where the conductor trace is patterned in a substantially spiral pattern. This antenna can remain in planar form, or be constructed into 3-dimensional shapes such as boxes or cylinders.

Yet another embodiment relates to an antenna. The antenna includes a substrate comprising of at least a first and second layer and a probe feed located on one of the first and second layer. The antenna also includes a load located on the other of the first and second layer and a via connecting the first and second layers. The antenna further includes a first conductor trace connecting the probe feed to a first end of the via in a spiral pattern and a second conductor trace connecting the load to a second end of the via in a spiral pattern.

### BRIEF DESCRIPTION OF THE DRAWINGS

Various features of the embodiments can be more fully appreciated as the same become better understood with reference to the following detailed description of the embodiments when considered in connection with the accompanying figures, in which:

FIG. 1 illustrates an exemplary antenna in accordance to an embodiment;

FIG. 2 illustrates a measured return loss graph according to yet another embodiment;

FIG. 3a illustrates a measured radiation performance at 1.84 GHz according to yet another embodiment;

FIG. 3b illustrates a measured radiation performance at 5.8 GHz according to yet another embodiment;

FIGS. 4a-c illustrate exemplary antennas in accordance to other embodiments;

FIG. 5 illustrates a multi-layered version of a planar folded Beverage antenna in accordance with yet another embodiment; and

FIG. 6a illustrates another folded Beverage antenna in accordance with yet another embodiment; and

FIG. 6b illustrates yet another folded Beverage antenna in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of antennas, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments generally relate to a folded printed Beverage antenna. More particularly, the folded printed Beverage antenna may be configured to include a conductor that is generally spiraled on top of a grounded substrate. In some embodiments, a probe feed is located at the center of the antenna, where the conductor is interfaced thereto. As the conductor spirals from the probe feed, the other end of the conductor is then connected to a load. The width of the conductor may be set to match the impedance of the load and the drive port impedance of the antenna. In other embodiments, the folded printed Beverage antenna may be fabricated on a multi-layer substrate to improve responsive bandwidth. In yet other embodiments, the folded printed Beverage antenna may be fabricated over three-dimensional structures.

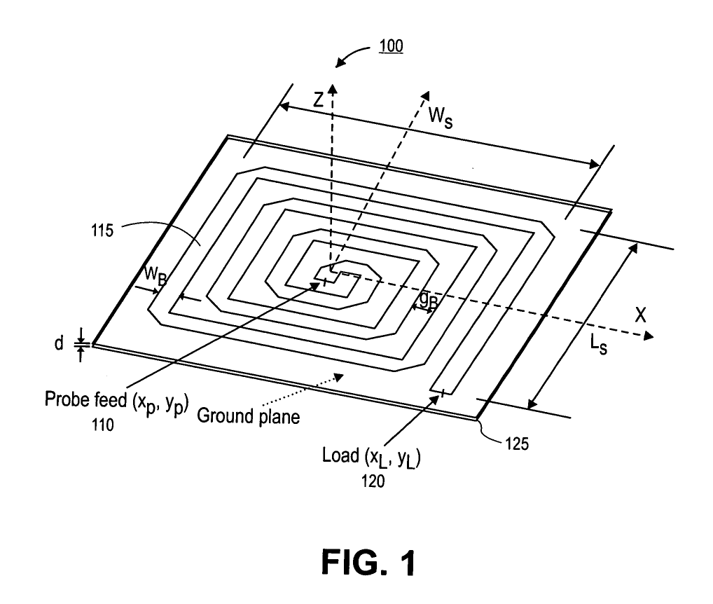

FIG. 1 illustrates a wideband omni-directional folded Beverage antenna 100 in accordance with an exemplary embodiment. It should be readily apparent to those of ordinary skill in the art that the folded Beverage antenna 100 depicted in FIG. 1 represents a generalized schematic illustration and that other components may be added or existing components may be removed or modified.

As shown in FIG. 1, the folded Beverage antenna 100 includes a probe feed 110, a conductor trace 115, a load 120, and a grounded substrate 125.

In one embodiment, the feed probe 110 may be soldered to the conductor trace 115. The conductor trace 115 may be configured to receive the electromagnetic signals. The conductor trace 115 may be implemented using materials such as copper, aluminum, other metallic conductors or combinations thereof. The conductor trace 115 has a width of w_{B} and a length of L_{B}. In some embodiments, the greater the L_{B}, the more efficient the folded Beverage antenna 100 will be at a lower frequency. For example, L_{B} greater than 5 wavelengths will yield an efficient solution. The conductor trace 115 may also be configured to spiral from the feed probe 110 to the load 120. As shown in FIG. 1, the spiral pattern is substantially rectangular with mitered corners. It should be readily apparent to those skilled in the art that other types of spiral patterns, for example, circular, arcuate, helical, etc., are contemplated with other embodiments.

The load 120 may be configured to match the impedance of the conductor trace 115 and to prevent reflections. The load 120 may be implemented using a chip resistor, a thin-film resistor or a beaded resistor depending on the frequency range of the antenna.

The grounded substrate 125 may be configured to grounded plane for the folded Beverage antenna 100. The grounded substrate 125 may be a thickness d and with a dielectric constant εᵣ. The thickness, d, can range from 0.0001 λ₀ (where λ₀ is the free space wavelength at the lowest frequency of operation) to greater than 0.2 λ₀. The dielectric constant, εᵣ, can range from 1 to values greater than 40. The grounded substrate 125 may be implemented using materials such as foam, polyimide, polyethylene, or ceramic based materials.

In one embodiment, a folded printed Beverage antenna was fabricated, where the overall area of the antenna was 150×150 millimeters (including the ground-plane). The antenna was fabricated utilizing standard printed circuit board etching procedures. An off-the-shelf SMA connector was incorporated to feed the folded antenna. The feed and load ports were located 2 mm from the beginning and end, respectively, of the conductor trace. A track was etched at the end of the conductor trace and a 50 Ohm resistor was soldered across the gap. In some other embodiments, the load may be in the form of a thin film resistor and may be located on the conductor trace, within the pin connecting the conductor trace to the ground plane, or at the ground plane itself. In addition, the load can be replaced with a matched termination port.

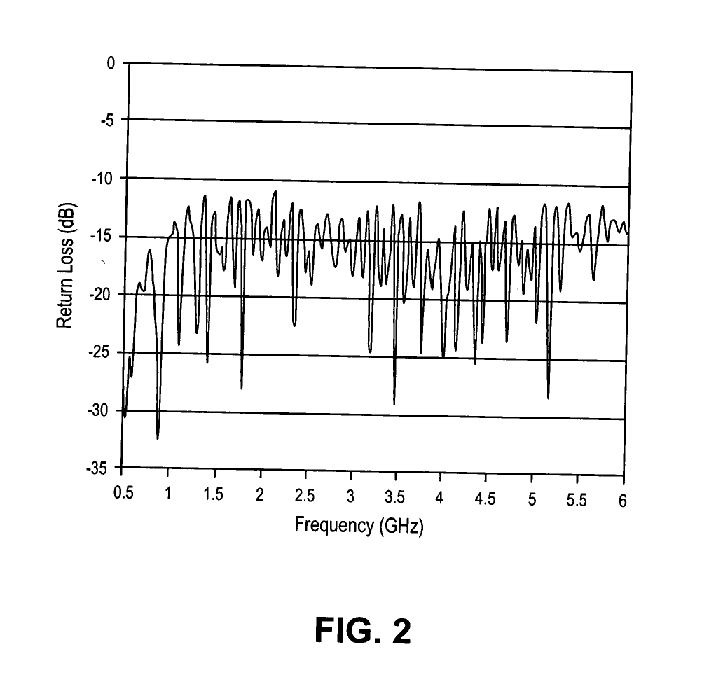

For the fabricated folded printed Beverage antenna, the return loss response was measured and is illustrated in FIG. 2. As shown in FIG. 2, the fabricated antenna easily satisfies the return loss requirements of less than −10 dB over the specified frequency range. This is as expected for a loaded antenna and is consistent with other forms of this class of radiator. The periodic ripples in the return loss are due to finite reflections from the connector (which was not time-gated out) and interactions with reflections from the mitered bends of the folded antenna.

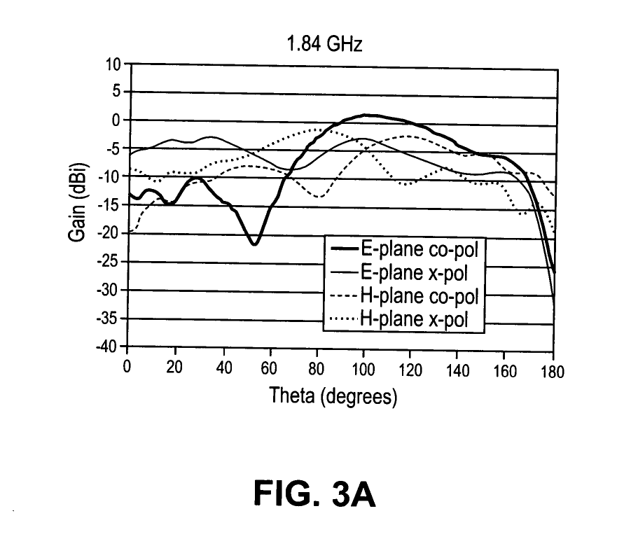

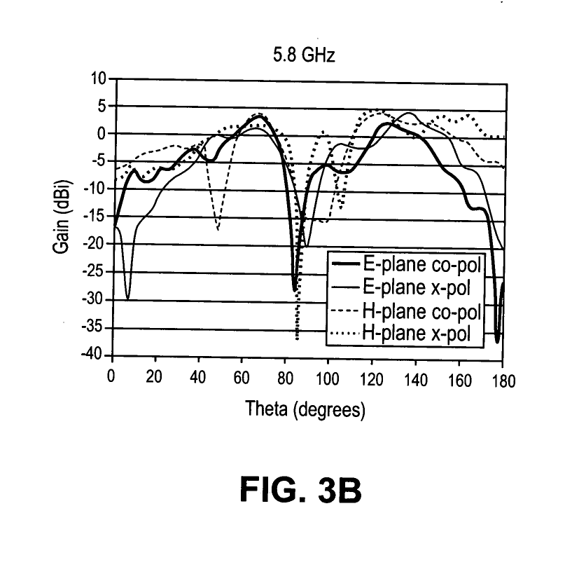

Moreover, FIGS. 3a-b illustrate the radiation patterns for the fabricated antenna in the principal planes (E and H-planes) across the specified frequency band (1.84 GHz and 5.8 GHz, respectively). As shown in FIGS. 3a-b, θ=90° corresponds to broadside. Moreover, the size constraints of the fabricated antenna may limit the gain the antenna, particularly at low frequencies. However, to improve the performance at lower frequency, the antenna may be fabricated larger, e.g., indoor wireless access terminals.

Returning to FIG. 1, the antenna 100 can be fed at the end of the radiator (where the load is illustrated in FIG. 1) and the load can then be located at the original position of the feed in some embodiments. Other embodiments include: using multi-layers of microwave laminates above and below the conductor; varying the width of the conductor track; and also varying the gap between the conductor tracks.

There are many design parameters associated with the new folded Beverage antenna and those which have major impact on the antenna response are: the characteristics of the material used to support the track conductor; the track width; the height of the conductor above the ground-plane; and the termination of the antenna. To achieve an ‘ideal’ traveling-wave response, this termination must be matched to that of the impedance of the transmission line. Doing so will prevent reflections at the end of the antenna and thereby reduce the likelihood of standing-wave effects in both the radiation patterns and the impedance response of the antenna.

The printed folded Beverage antenna has an improved radiation performance when the height of the substrate is increased, however doing so can compromise the input impedance response due to the discontinuity associated with the feeding mechanism as well as that associated with the load. Another consequence of using thicker material for the substrate is that the track width becomes wider which impacts the overall size of the radiator since the greater the thickness, the larger the area required to accommodate bends in the folded antenna. This can be circumvented somewhat by using higher dielectric constant substrates, at the expense of radiation efficiency.

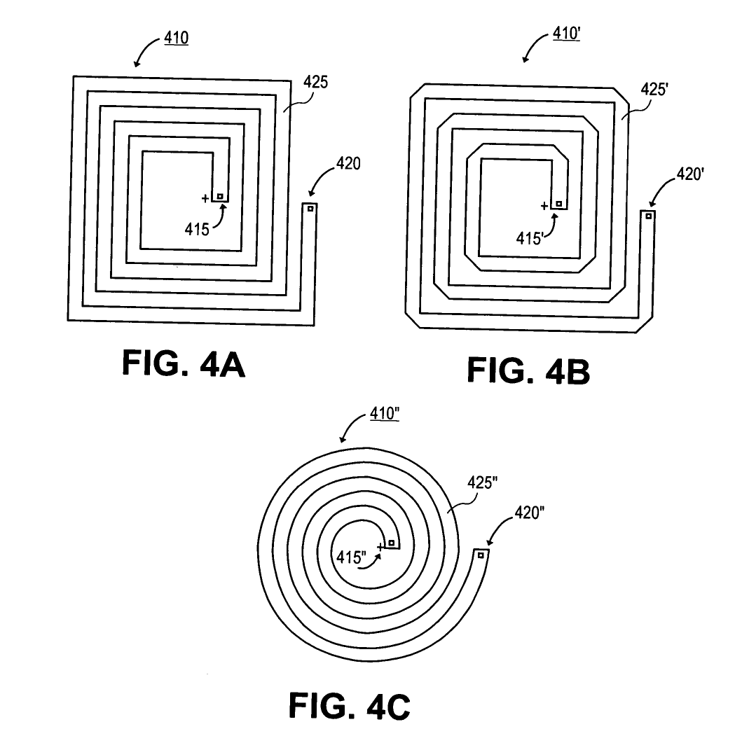

FIG. 4a illustrates a rectangular spiral folded Beverage antenna 410 in accordance with another embodiment of the invention. As shown in FIG. 4a, the folded Beverage antenna 410 includes a probe feed 415, a load 420 and a conductor trace 425. The conductor trace 425 is in a rectangular spiral pattern over a grounded substrate (not shown). The probe feed 415 may be located in substantially in the center and the load 420 may be located substantially on the edge of the grounded substrate. However, in other embodiments, the locations of the probe feed 415 and load 420 may be reversed.

FIG. 4b illustrates a rectangular spiral folded Beverage antenna 410′ with mitered corners in accordance with yet another embodiment. Like the embodiment shown in FIG. 4a, the antenna 410′ includes a probe feed 415′, a load 420′ and a conductor trace 425′. The conductor trace 220′ may be patterned in a rectangular spiral pattern with mitered corner from the probe feed 415′ to the load 420′.

FIG. 4c illustrates a circular spiral folded Beverage antenna 410″ in accordance with yet another embodiment. Like the embodiment shown FIGS. 4ab, the antenna 410″ includes a probe feed 415″, a load 420″ and a conductor trace 425″. The conductor trace 420″ may be patterned in a circular spiral from the probe feed 415″ to the load 420″.

The optimal thickness for the embodiments of the folded Beverage antenna may be difficult to determine. Generally, as the substrate thickness is increased, the antenna becomes more efficient, which can be simplistically attributed to the fact that as the width of a microstrip line increases, more energy is radiated. Thus, as the energy travels embodiments of the folded Beverage antenna, more of it is efficiently coupled to free space. However, one issue associated with folded Beverage antennas mounted on thick substrates is that as the thickness increases, the impedance mismatch associated with the probe feed becomes more pronounced, in a similar manner to a probe-fed microstrip patch antenna. This effect will be most dramatic at the higher frequencies of operation where the material is electrically thick.

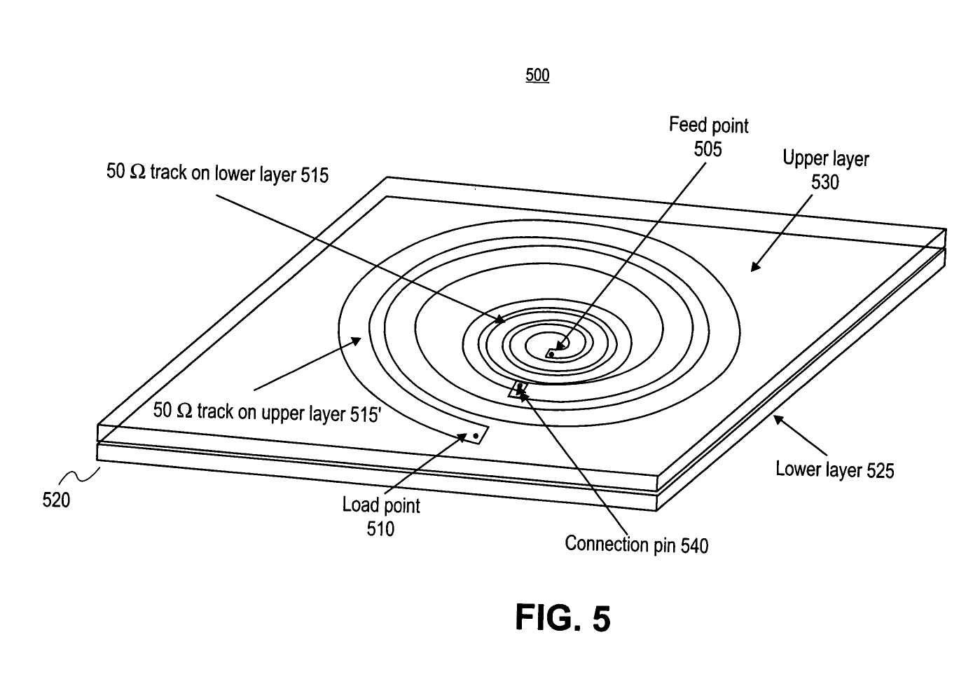

In order to overcome the impedance mismatches with thick substrates, an embodiment of the folded Beverage antenna that includes multiple layers in the substrate that overcomes the compromise in performance at higher frequencies when using thick material. A multi-layered approach is used to resolve the frequency dependent nature of the trade-off between the material and the overall efficiency of the antenna. More specifically, for any traveling-wave antenna using a transmission line, the low frequency end of operation prefers a long spiral mounted on an electrically thick substrate. The improvement in performance however comes at the expense of the upper frequency response, which exhibits degradation in both the return loss behavior and the radiation performance. One means of overcoming this drawback is to develop a multi-layered spiral structure, where the lower substrate is optimized for the higher frequencies and the upper layer is designed to satisfy the lower frequencies. Most importantly, the antenna still has a single feed point, which is discussed with respect to FIG. 5.

FIG. 5 illustrates a multi-layered version of a planar folded Beverage antenna in accordance with yet another embodiment. As shown in FIG. 5, the antenna 500 includes a feed point 505, a load point 510, a conductor trace 515 and a grounded substrate 520. Similar to other embodiments, the conductor trace 515 may be configured to be in a spiral pattern from the feed point 505 to the load point 510. However, the grounded substrate 520 may be configured in multiple layers 525, 530.

As shown in FIG. 5, the feed point 505 may be centrally located on the layer 525. Conductor trace 515 (labeled as 50 Ω on lower layer) may be configured to spiral in several winds from the probe feed 505 to interface with one end of connecting pin (or via, contact, etc.) 540. The connecting pin 540 may be configured to provide an electrical conduit from one layer to another layer. Conductor trace 515′ on layer 530 (labeled as 50 Ω on upper layer) may be configured to interface with the second end of connecting pin 540 and continue in a spiral pattern to the load point 510. It should be readily apparent to those skilled in the art that the position of the feed point 505 and load point 510 may be reversed in other embodiments.

In the embodiment shown in FIG. 5, two design philosophies can be considered when implementing embodiments of the folded Beverage antenna. Firstly, the second layer of material can have a low dielectric constant (close to unity) as the radiation efficiency of the new printed antenna will be substantially degraded at higher frequencies due to the large proportion of energy dumped into the surface wave. Secondly, the width of the track of the upper segment of the spiral can still be 50 Ω to ensure that there are minimal reflections at the transition from the lower spiral to the upper spiral.

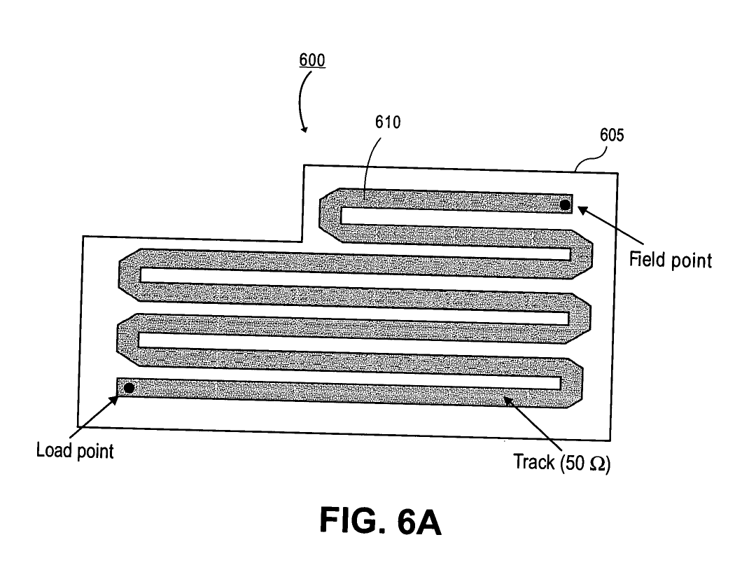

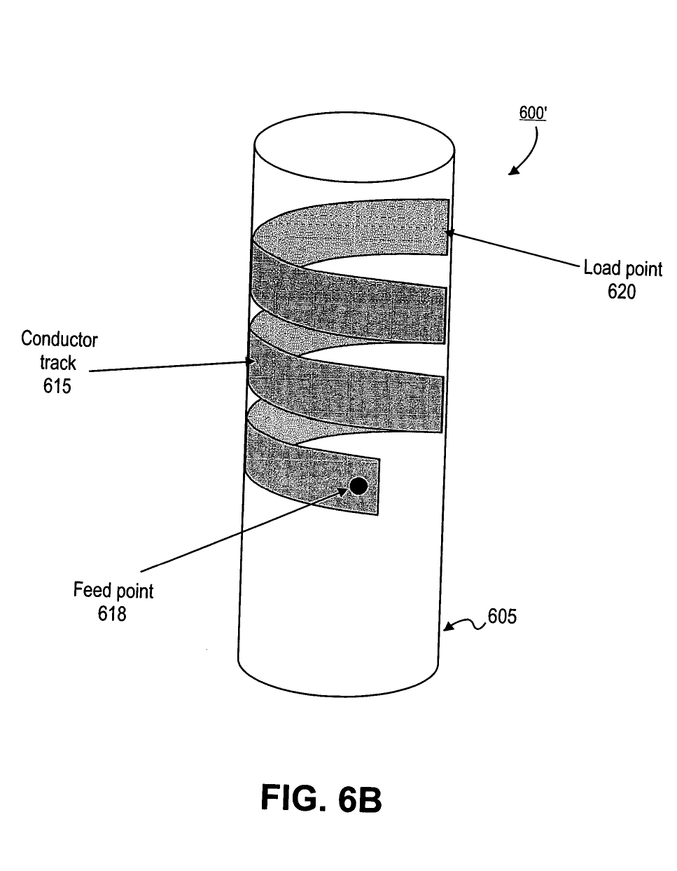

The overall shape of the embodiments of the inventive folded Beverage antenna need not be confined to planar structures or restricted to spiral shapes. For example, FIG. 6a shows an embodiment of the folded Beverage antenna configured to be folded in a required installation location. More particularly, as shown in FIG. 6a, the folded Beverage antenna 600 may be confined to area 605. The conductor trace 610 has been configured to fit in area 605 in a spiral pattern.

As another example, FIG. 6b illustrates an embodiment of the folded Beverage antenna formed on a three-dimensional structure. As shown in FIG. 6b, the antenna 600′ is formed over a cylinder 605. Feed point 610 may be located on the cylinder 605. The conductor trace 615 may be placed around the cylinder 605 to form a helical path to the load point 615. The angle of helical path of the conductor trace 615 as well as the length of the conductor trace 615 may depend on the wavelength of the antenna 600′. It should be readily apparent to those skilled in the art that other three-dimensional structures could be used in other embodiments.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A wave antenna comprising:
a grounded substrate;
a probe feed configured to be substantially centered within the grounded substrate;
a load configured to be a linear distance from the probe feed; and
a conductor trace configured to connect the probe feed and the load, wherein a pattern for the conductor trace is substantially a spiral and a radiation response of the wave antenna is substantially omni-directional.

2. The wave antenna according to claim 1, wherein the spiral includes at least one mitered corner.

3. The wave antenna according to claim 1, wherein the spiral is circular.

4. The wave antenna according to claim 1, wherein the spiral is a rectangular spiral.

5. The wave antenna according to claim 1, wherein the grounded substrate has a thickness d and a dielectric constant εᵣ.

6. The wave antenna according to claim 5 wherein the thickness d-ranges between 0.0001 λ₀ to 0.2 λ₀.

7. The wave antenna according to claim 5, wherein the dielectric constant εᵣ ranges between 1 and 40.

8. The wave antenna according to claim 1, wherein the conductor trace has a width that ranges between 0.01 λ₀ and 0.1 λ₀.

9. A three-dimensional wave antenna, comprising:
a three dimensional structure comprised of a grounded substrate;
a probe feed configured to be substantially located on one end of a surface of the three dimensional structure;
a load configured to be located on a second end of the surface of the three dimensional structure; and
a conductor trace configured to connect the probe feed and the load, wherein a pattern for the conductor trace is substantially a spiral over the surface of the three dimensional structure.

10. The three-dimensional wave antenna according to claim 9, the grounded substrate has a thickness d and a dielectric constant εᵣ.

11. The wave antenna according to claim 10 wherein the thickness d ranges between 0.0001 λ₀ to 0.2 λ₀.

12. The wave antenna according to claim 9, wherein the dielectric constant εᵣ ranges between 1 and 40.

13. The wave antenna according to claim 9, wherein the conductor trace has a width that ranges between 0.001 λ₀ to 0.1 λ₀.

14. A method for forming a wave antenna, comprising:
providing a grounded substrate, the grounded substrate having a length, a width and a height dimension;
providing a probe feed to be substantially located in a center of the grounded substrate;
providing a load to be substantially located on an edge of the grounded substrate; and
providing a conductor trace from the probe feed to the load, wherein the conductor trace is patterned in a substantially spiral pattern.

15. The method according to claim 14, wherein the spiral pattern is substantially arcuate.

16. The method according to claim 14, wherein the spiral pattern includes at least one mitered corner.

17. The method according to claim 14, wherein the grounded substrate has a dielectric constant εᵣ.

18. An antenna comprising,
a substrate comprising of at least a first and second layer;
a probe feed located on one of the first and second layer;
a load located on the other of the first and second layer;
a via connecting the first and second layers;
a first conductor trace connecting the probe feed to a first end of the via in a spiral pattern; and
a second conductor trace connecting the load to a second end of the via in a spiral pattern.

19. The antenna according to claim 18, wherein the first layer has a depth that ranges from 0.0001 λ₀ to 0.2 λ₀.

20. The antenna according to claim 18, wherein the second layer has a depth that ranges from 0.0001 λ₀ to 0.2 λ₀.
